(19) United States
(12) Patent Application Publication
(10) Pub. No.: US 2018/0132491 A1
(43) Pub. Date: May 17, 2018

(54) DIPPING PIZZA PAN SYSTEM

(71) Applicant: Charles AVANT, Cataula, GA (US)

(72) Inventor: Charles AVANT, Cataula, GA (US)

(73) Assignee: Charles AVANT, Catuala, GA (US)

(21) Appl. No.: 15/809,877

(22) Filed: Nov. 10, 2017

Related U.S. Application Data
(60) Provisional application No. 62/421,236, filed on Nov. 12, 2016.

(51) Int. Cl. A21C 11/00; A21D 13/41; A21D 8/02; A47J 43/28

(52) U.S. Cl. CPC A21C 11/004; A47J 43/28; A21D 8/02; A21D 13/41

(57) ABSTRACT

A dipping pizza pan system provides a structure to facilitate the preparation of a volcano pizza with a centered edible dipping sauce container that is suited for home or commercial use. The system includes a cylindrical structure having a template at one end for forming a bowl structure and two stackable pizza pans. The upper stacked pan has an opening to provide access to the template on the upright cylinder placed or affixed to the lower stacked pan. The cylinder is either affixed to the lower pan surface or positioned and held in place on the lower pan by the collective action of the upper pan opening and stacked edges of the upper and lower pans. The assembled or dipping pizza pan system elements can be packaged in a kit form for home or commercial use.

### CROSS-REFERENCE TO RELATED APPLICATIONS

This application claims the benefit of provisional application No. 62/421,236, filed Nov. 12, 2016, which is incorporated herein by reference in its entirety.

### BACKGROUND

This invention relates to a pan system for commercial or home use in making a volcano pizza, one having the appearance of an integral a bowl for containing a dipping sauce and a pizza portion and a method which uses the pan system.

A preparatory method for a “Volcano” Pizza, which includes a dipping bowl, is described in a video appearing at https://www.popsugar.com/food/Volcano-Pizza-Food-Video-40658597. “Volcano” describes the visual effect of a centered dipping bowl container and a pizza surrounding that container where the dipping sauce can flow over the container walls. Shown in the video is the manual preparation of a volcano pizza in a home setting.

The pizza industry has focused on a various preparatory methods and devices to address various problems: achieving and maintaining a crispy crust (U.S. Pat. No. 3,347,181, U.S. Pat. No. 4,785,968 and U.S. Pat. No. 5,503,063); insuring the evenness of the baking process (U.S. Pat. No. 5,925,5591); and creating a uniform pizza in a commercial environment (U.S. Pat. No. 9,198,437 and U.S. Pat. No. 9,364,008).

None of the cited patents is concerned with the preparation of a “volcano pizza” in a commercial setting and preparing the pizza in the volume required for home delivery where a uniform pizza product is required.

### SUMMARY OF THE INVENTION

In one aspect of the present invention, a dipping pizza pan system has been developed to facilitate the preparation of a pizza having an edible container in its center that contains a dipping sauce. The system includes a hollow cylindrical structure or a solid one that has a cavity that serves as a template for forming a bowl structure and two stackable pans, an upper one with an opening for the upright cylinder and a lower pan with a horizontal planar surface that supports the cylinder in an upright position. The stacked pan system secures the cylinder in an upright position and so that the bowl forming template, hollow structure or bowl shaped cavity, is accessible to a dough sheet draped over the stacked pan system. The access permits manipulation of the sheet to form a bowl and pizza portion by pressing or folding the dough into place. The bowl can be shaped by pressing the dough against the walls of the template cavity or by folding the dough within the confines of the open cylinder. The surrounding pizza portion is formed from the remaining portions of the dough sheet positioned over the stacked system. The outer crust of the pizza is formed using the outer edge of the upper pan as a guide. As an alternative to relying on the interplay of the opening in the upper pan to stabilize the cylinder for use as a template, the cylinder can be physically attached (secured) to the horizontal surface of the lower pan or manufactured to be an integral structure of the lower pan. In any event, the two pans when stacked insure that the opening of the hollow cylinder or the template cavity is accessible to the dough sheet place over the stacked pans. The raised outer edge is of sufficient height to serve as a guide for forming the crust structure and to form a rigid stacked pan system. This is achieved in part due to the continuous contact of the edges and the horizontal planar surfaces. The pans are made from conventional materials, e.g. metals such as aluminum.

In another aspect of the invention, the upper pan and lower pans can have a recessed portion defined by a second continuous edge within the outer edge used as a guide to form the dough crust. The recess is defined by the second inner edge and the horizontal surface of the pan. The recess, which is optional, can serve as a template for forming a deep dish-like pizza.

In still another aspect of the invention, the system is assembled and used as a template in the preparation of a uniform pizza structure from a series of dough sheets. The system allows an assembly line approach to prepare volcano pizzas. The shape of the pizza is uniform. Uniformity permits standardization of the cooking process. The ability to prepare a uniform product pizza also permits the preparation of pizza in the volumes that facilitate home delivery and heavy traffic times at a pizzeria. Preparation includes the steps of placing a sheet of dough over the stacked upper pan and the template and shaping the dough sheet to fit the contours of the upper pan and the template. The formed pizza portion and bowl remained attached until separated by a cutter, e.g. a circular cookie cutter. The bowl is generally separated after baking and placed in the center of the pizza in the recess resulting from its removal. The dipping sauce can be added at any time and in amounts to produce the volcano appearance. The pizza portion can be sliced before or after the upper pan is separated.

In yet another aspect of the invention, the pizza system of the invention can be provided in kit form for home or commercial use. The kit facilitates handling and use, especially for use in pizza chains and home use. The pan and cylinder elements of the lit can be assembled (stacked), partially assembled or as the individual elements. The kit can include any desired written materials, e.g. instructions for use and assembly or with recipes or ingredients, and a cutting tool, e.g. a circular cutting tool sized to separate the bowl from the cylinder and the pizza portion.

### BRIEF DESCRIPTION OF THE DRAWINGS

FIG. 1 shows a top view of the stacked pan system where the upper pan that has a centered opening for a cylinder structure with an open upper end that is used to aid in fashioning a bowl structure, made from a dough sheet, which bowl can hold dipping sauce.

FIG. 2 shows a side view of an individual pan with a recessed portion.

FIG. 3 is a photograph of the embodiment where the cylinder structure is attached (secured) to the lower pan. Included in the photograph, is a cylinder with an irregular an irregular upper edge. The cylinder edge can be irregular or flat.

FIG. 4a shows a perspective view of the cylinder structure with an open end that is used to fashion a bowl, from a dough sheet by folding. The upper edge can be straight (flat as shown) or irregular. FIG. 4b shows a side view of that container. The cylinder, as shown, is depicted with a lip on its lower edge. This adds stability when the cylinder is in an upright position.

FIG. 5 shows a view of a partially assembled dipping pizza pan system where the cylinder having an open end is placed on a bottom pan and the opening in the top pan receives the upper end of the cylinder and centers the cylinder on the bottom pan when the pans are stacked.

FIG. 6 is a photograph of a disassembled dipping pizza pan system where the cylinder is attached (secured) to the lower pan. The lower pan is similar to that shown in FIG. 5. The photograph also includes an optional circular cutting tool where a handle is secured to opposite sides of the cutting tool.

FIGS. 7a-7e is a series of photographs illustrating the steps involved preparing the volcano pizza—the edible bowl structure and pizza portion. FIG. 7a shows the preparation of the dough sheet; FIG. 7b shows the placement of the dough sheet over the stacked pans with the cylinder in an upright position; FIG. 7c shows the formation of the bowl structure by folding the dough into a bowl shape; FIG. 7d shows the formation of the crust using the outer edge of the upper pan as a guide; and FIG. 7e shows the introduction of vents near the bowl structure using a fork.

FIG. 8 shows an alternative design for the handle of the circular cutting tool where the handles are opposite to one another and extend in an outward direction.

### DETAILED DESCRIPTION OF THE INVENTION

Embodiments of the invention will be described with reference to the accompanying drawings and figures wherein like numbers represent like elements throughout. Further, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items. The terms “mounted”, “connected”, and “coupled” are used broadly and encompass both direct and indirect mounting, connecting and coupling. Further, “connected” and “coupled” are not restricted to physical or mechanical connections or couplings.

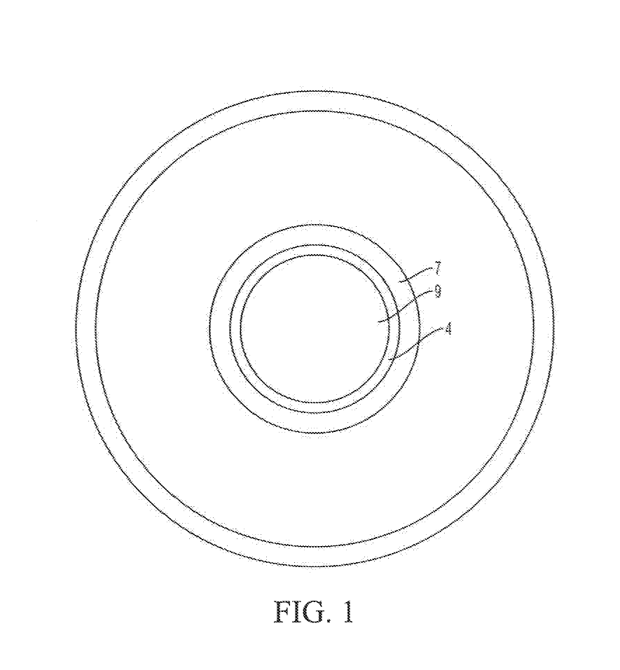

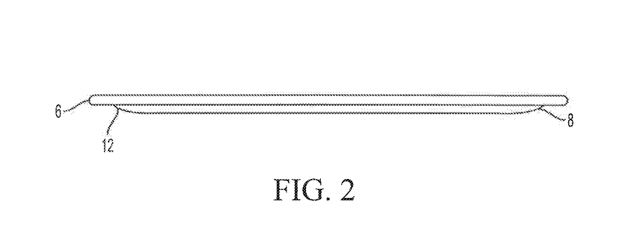

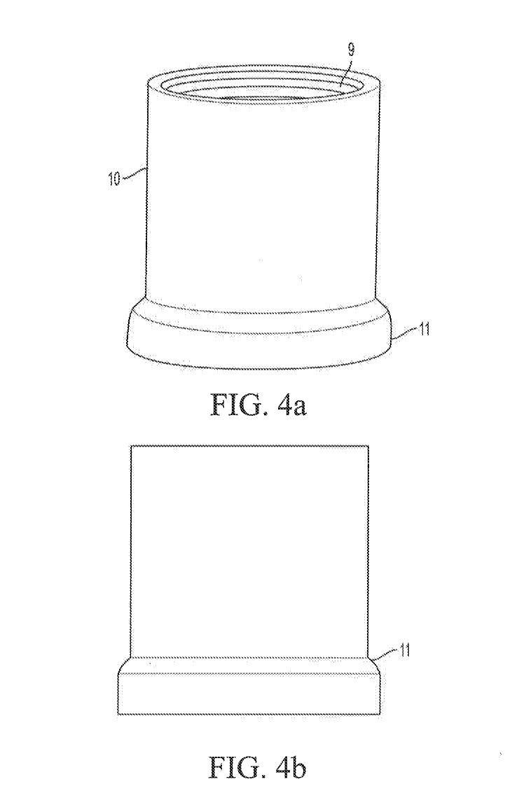

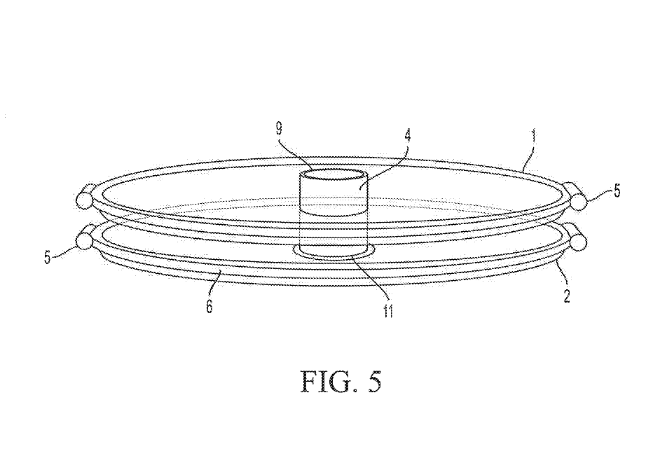

The components of the dipping pizza pan system are shown in FIG. 5 as a partially assembled system, which illustrates the relationships between the component parts. The pan system includes a lower pan (2), an upper pan (1), and a cylindrical structure (ramacan) (4). As shown, the cylindrical structure (4) sits in an upright position on the horizontal surface of the lower pan (2) and extends through the center opening (12) of the upper pan (2). The cylinder is held in a stable upright position by the collective action of the sides of the opening (12), the outer surface of the cylinder and the stacked pans. A rigid structure is formed. Not shown in FIG. 5 are the embodiments where the cylindrical structure is centered on the lower pan and fixed in place or is manufactured as an integral part of the lower pan at the center of the pan. An overview of the stacked pan system is shown in FIG. 1—circular upper pan (1), top edge of the upright cylinder and the opening (12) of the upper pan. A pan side view is shown in FIG. 2. Both the upper and lower pans are similar in shape with the exception that the upper pan has an opening in its center. The pans are stackable. FIGS. 4a and 4b show the cylindrical structure (ramacan). A perspective view is shown in FIG. 4(a) and a side view is shown in FIG. 4(b), respectively. The lower edge of the cylinder can have a lip, to promote stability for the cylinder, when placed on the horizontal surface of the lower pan. The dimensions of the cylinder are selected so that the template (opening) results in a bowl having the desired size and shape.

Additionally, FIG. 5 shows the upper and lower pans with handles (5) attached to the outer edge of the pans. These handles can be fixed or temporary structures. The temporary structure can clip onto and secure the outer raised edge (6). When stacked, the outer edges and planar surfaces of the pan (6) are in contact to form a rigid structure. The edges are of sufficient height to serve as a guide for forming a crust. The upper pan has a central opening (7) that receives and positions the upright cylinder structure (4). The stacked rigid pan system firmly holds the cylinder in place so that the dough sheet can be formed into a bowl structure and pizza portion. As shown, the pans have a recess structure (8) is defined by the horizontal planar surface and a continuous second edge (12) located near but within the outer edge (6). The recess (8) allows the dough to be shaped to form a deep dish-like pizza shape. See FIG. 2. The recess (8) is optional. If absent, the dough would be formed as a flat pizza crust.

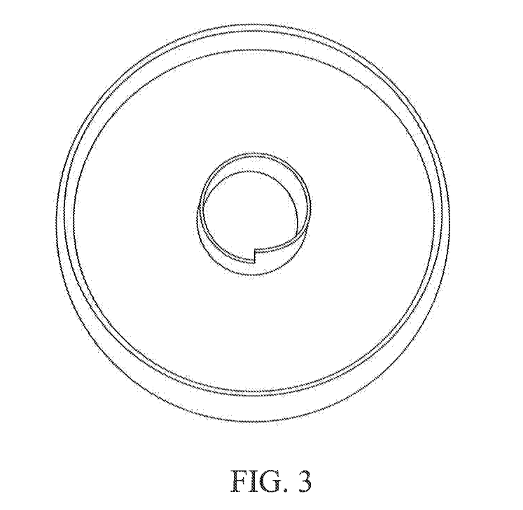

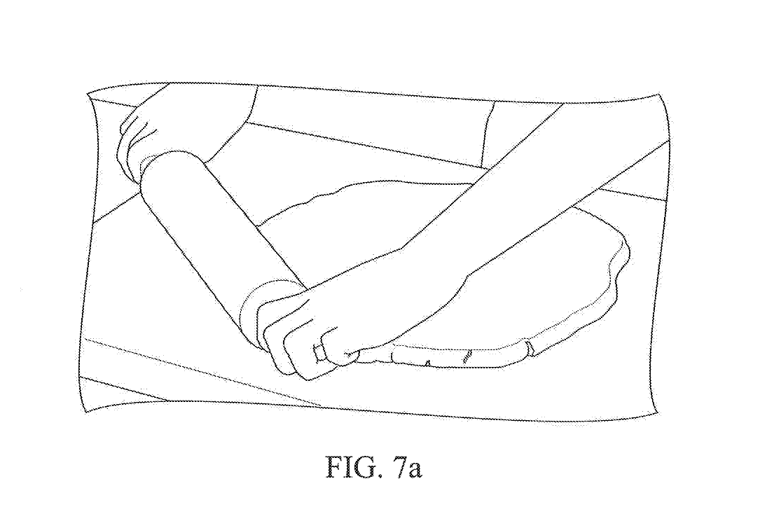

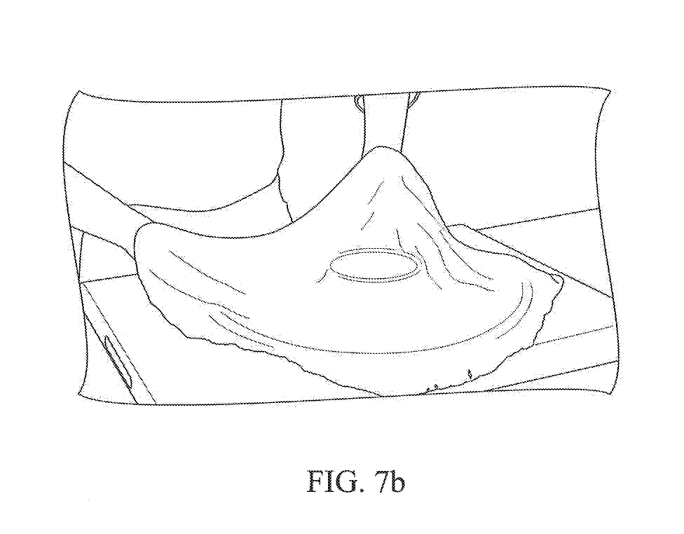

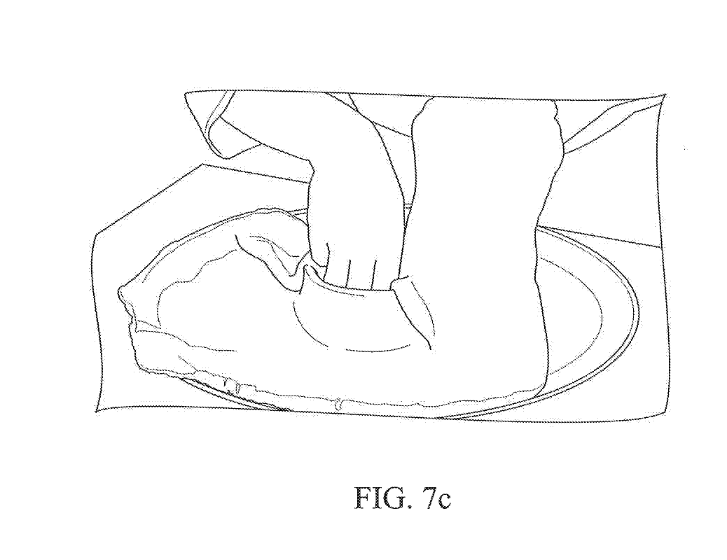

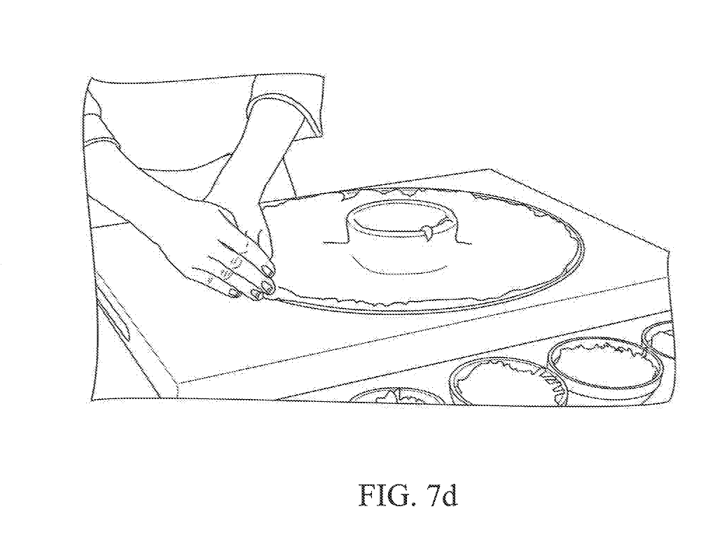

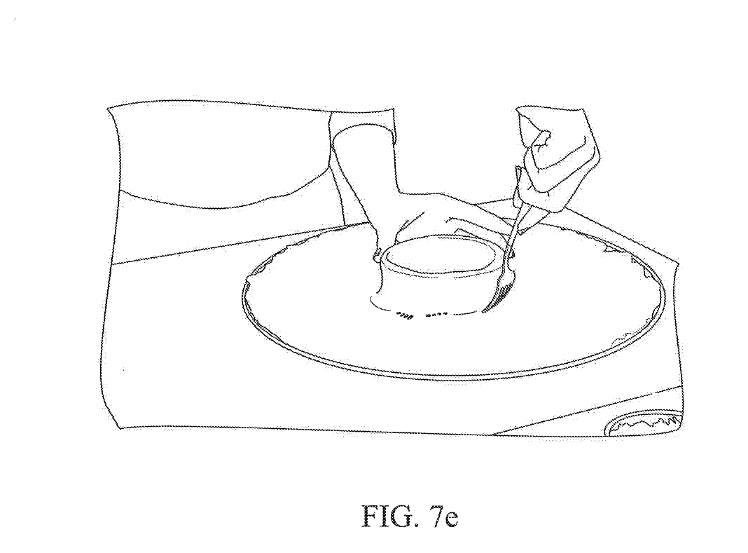

The raised edge (6) of the upper pan is of a sufficient height to aid in the shaping and forming of the outer crust. The preparation of the “volcano pizza” is shown in figures See FIG. 7a-e. The cylinder structure (4) can be a solid structure with hemi-spherical cavity on its upper surface or a hollow cylinder. The cavity (template) (9) is shown for example in FIGS. 1, 3, 4(a), 6 and 7(b)-(e). If the cylinder is a hollow cylinder, the bowl is formed by folding the dough sheet within the cylinder structure. See FIG. 7(c). If the cylinder has a template, the bowl is formed by pressing dough sheet against the walls of the cavity. The surfaces can be coated with oil. The consistency and thickness of the dough depends on the pizza type and bowl.

The shape of the pans is not limited to circular. The shape merely needs to permit the upper and lower pans to be stackable and to allow the cylinder structure to be centered on the lower pan.

Typically, bowl structure is formed from the same dough sheet as the pizza portion. The horizontal pizza portion and the bowl are separated after baking using a circular cookie cutter type tool or other appropriate tool. A fork is used to provide dough vents to facilitate baking. The diameter of the circular cutting tool is selected to accommodate the dough and the diameter of the upright cylindrical structure. The diameter of the cutting tool can be adjustable or multiple tools included providing varying diameters. The bowl is typically separated from the pizza portion after baking and prior to lifting the upper pan (1) with the pizza portion from the lower pan (2). The upper pan can serve as a serving tray. The bowl is placed in the recess formed in the pizza by its removal.

The system can be used in a commercial or home setting. The oven type used is not critical. However, heat is generally supplied from above.

The measurements and dimensions are not critical. Here, the pans have a diameter of sixteen inches. The cylinder structure chosen had a height of 1.8 inches and an outer diameter of 3.23 inches and a thickness of 0.10 inch. The circular cutting tool had a diameter of 3.24 inches and 1.8 to 2 inches in height. This allows the bowl to be separate from the rest of the pizza once cooked.

### EXAMPLE

The cylindrical structure is placed on the lower pan. The opening of the second pan is aligned with the upright cylindrical structure and lowered onto the lower pan so that the pans are stacked and the cylinder locked in place. This insures the upright position of the cylinder is sufficiently stable to act as a template when the dough sheet is place over the stacked structure. Pizza dough is rolled to form a sheet of desired thickness and size to cover the stacked pans. A bowl is fashioned in the opening of the upright cylinder by folding the dough to fit within the hollow cylinder. See FIG. 7a-7e. The outer crust is formed along the outer edge of the upper pan. Olive oil can be applied to coat the surface of the pizza portion and bowl prior to baking and forming the dough structure. The desired pizza ingredients are added and the dough structure baked.

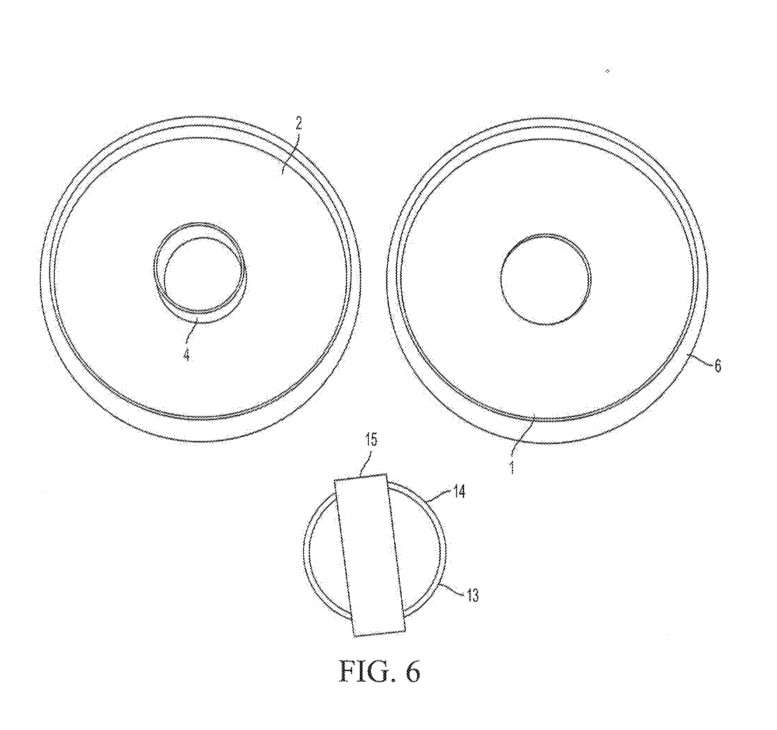

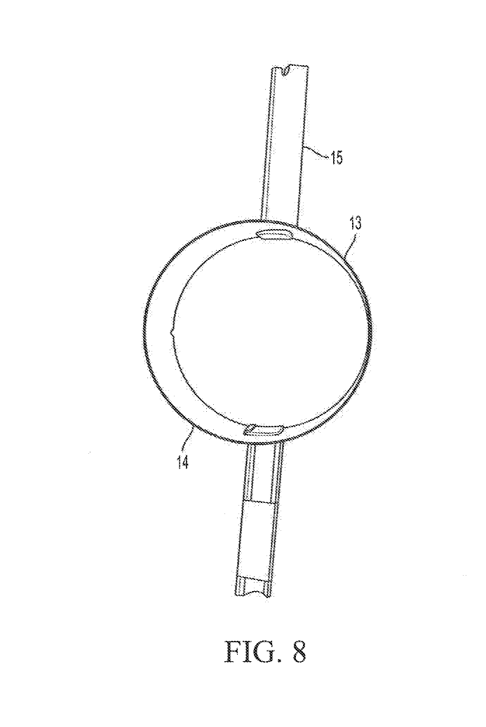

After baking, the pizza portion and bowl are removed from the oven. The bowl is separated from the pizza portion by use of a cutting tool; preferably, a circular cutting tool (13) shown in FIGS. 6 and 8. The tool includes a circular cutting edge (14) and an attached handle (15) for use. A handle for the circular tool can connect opposite sides or extend outwardly from the opposite sides to form paired handles that are directed in outward directions.

The pizza portion is removed from the stacked pans by lifting the upper pan. The bowl can be separated before or after the pizza portion is removed. The bowl is placed in the opening formed by its removal from the pizza portion. The dipping sauce is added to the bowl, when desired.

Although the invention herein has been described with reference to particular embodiments, it is to be understood that these embodiments are merely illustrative of the principals and applications of the present invention. Accordingly, while the invention has been described with reference to the structures and processes disclosed it is not confined to the details set forth, but is intended to cover such modifications or changes as may fall within the scope of the following claims.

What is claimed is:

1. An assembled dipping pizza pan system comprising,
a cylindrical structure with at least one open end, where the opened end forms a cavity of sufficient size to serve as a template for forming a bowl from a dough sheet and the other end is either open or closed, and
two stackable pizza pans, upper and lower, having raised outer edges, where, when stacked, include a lower pan having a horizontal surface between the edges upon which the end of the cylinder opposite to the end with the template is placed or centrally affixed and the upper pan in the stack has an centered opening that receives the upright cylinder and provides accessibility of the template to the dough sheet,
wherein, when the upper and lower pans are stacked, the outer raised edges of the upper and lower pans are in direct contact, and
the horizontal surfaces of the stacked pans are in substantial contact.

2. The dipping pizza pan system of claim 1, wherein the upper and lower pans have symmetrical recesses where the recess is defined by the horizontal surface and downward directed inner edge coextensive with the outer raised edge.

3. The dipping pizza pan system of claim 1, wherein the opposite end of the cylinder is fixed to the lower pan or is an integral part of the structure of the lower pan.

4. The dipping pizza pan system of claim 1, wherein the opposite end of the cylinder is centrally positioned on the lower pan by the collective action of the opening in the upper pan and the continuous contact of the outer edges of upper and lower pans.

5. A method of preparing and serving a pizza comprising the steps of:
placing a sheet of dough over the upper pan and the template of the upright cylindrical structure of the assembled dripping pizza pan system of claim 1, and
shaping the dough sheet to form a bowl by folding or pressing within the template of the upright cylinder and the pizza portion by pressing the sheet against the horizontal surface of the upper pan.

6. A kit for preparing and serving pizza comprising the elements of the system of claim 1.

7. The kit of claim 6 further comprising a circular cutting tool.

8. The kit of claim 7 wherein the circular cutting tool has a handle positioned on opposite sides of the circular tool.

9. The kit of claim 8 where in the handle connects both sides and is rigid.
